(19) United States
(12) Patent Application Publication
(10) Pub. No.: US 2016/0092664 A1
(43) Pub. Date: Mar. 31, 2016

(54) ELECTRONIC APPARATUS, AUTHENTICATION METHOD AND STORAGE MEDIUM

(71) Applicant: Kabushiki Kaisha Toshiba, Tokyo (JP)

(72) Inventor: Toshitaka Sanada, Ome Tokyo (JP)

(21) Appl. No.: 14/676,656

(22) Filed: Apr. 1, 2015

Related U.S. Application Data
(60) Provisional application No. 62/055,867, filed on Sep. 26, 2014.

(51) Int. Cl. G06F 21/32; G06F 21/45

(52) U.S. Cl. CPC G06F 21/32; G06F 21/45

(57) ABSTRACT

According to one embodiment, an electronic apparatus includes an input controller and circuitry. The input controller is configured to receive a password. The circuitry is configured to detect an external device which is externally connected, and to determine whether the password received by the input controller matches a password set in association with the detected external device.

### CROSS-REFERENCE TO RELATED APPLICATIONS

This application claims the benefit of U.S. Provisional Application No. 62/055,867, filed Sep. 26, 2014, the entire contents of which are incorporated herein by reference.

### FIELD

Embodiments described herein relate generally to an electronic apparatus, an authentication method, and a storage medium.

### BACKGROUND

Recently, electronic apparatuses which can be powered by battery and carried easily such as note-type personal computers (PCs) have become widely used. This type of electronic apparatus comprises the function of setting a password as security measures for preventing the electronic apparatus from being illicitly used by a person other than the authorized user.

When a password is set, even in an environment in which the possibility of fraud use is extremely low such as at home and in a company, the password must be input every time the electronic apparatus is to be used. Accordingly, the convenience of the electronic apparatus is deteriorated. However, if no password is set for this type of electronic apparatus which has good portability and can be used in various environments such as the place of visiting and when on the move, the electronic apparatus is subjected to fraud use once another person (a person other than the authorized user) is given the opportunity to use it. Also, when a simple password is set giving priority to convenience, the possibility of the electronic apparatus being used illicitly is high because the password may be broken by, for example, a peep or a guess.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an appearance of an electronic apparatus of an embodiment.

FIG. 2 is an exemplary diagram showing a system structure of the electronic apparatus of the embodiment.

FIG. 3 is an exemplary drawing showing an example of setting of passwords according to an environment in which the electronic apparatus of the embodiment is placed.

FIG. 4 is an exemplary diagram showing functional blocks of a password control module which operates on the electronic apparatus of the embodiment.

FIG. 5 is an exemplary drawing showing an example of a user interface screen (a main screen) for password setting which is displayed by the electronic apparatus of the embodiment.

FIG. 6 is an exemplary drawing showing an example of a user interface screen (a subscreen) for password setting which is displayed by the electronic apparatus of the embodiment.

FIG. 7 is an exemplary flowchart showing procedures of password setting processing executed by the electronic apparatus of the embodiment.

FIG. 8 is an exemplary flowchart showing procedures of password authentication processing executed by the electronic apparatus of the embodiment.

### DETAILED DESCRIPTION

Various embodiments will be described hereinafter with reference to the accompanying drawings.

In general, according to one embodiment, an electronic apparatus comprises an input controller and circuitry. The input controller is configured to receive a password. The circuitry is configured to detect an external device which is externally connected, and to determine whether the password received by the input controller matches a password set in association with the detected external device.

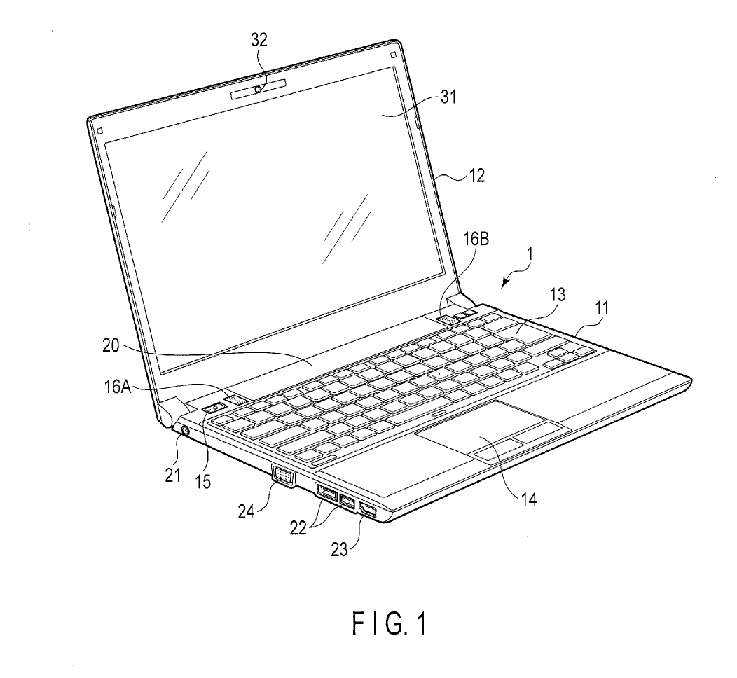

FIG. 1 is an exemplary view showing an appearance of the electronic apparatus of the present embodiment. As shown in FIG. 1, the electronic apparatus is realized as a note-type PC 1, for example.

FIG. 1 is an exemplary perspective view of the PC 1 with a display unit in an open state as seen from the front side. The PC 1 is configured to receive power from a battery 20. The PC 1 comprises a main body 11 and a display unit 12. In the display unit 12, a display such as an LCD 31 is incorporated. Also, at an upper end portion of the display unit 12, a camera (a web camera) 32 is arranged.

The display unit 12 is attached to the main body 11 such that it is rotatably movable between an open position at which an upper surface of the main body 11 is exposed and a closed position at which the upper surface of the main body 11 is covered by the display unit 12. The main body 11 comprises a thin box-shaped housing, and on an upper surface of the housing, a keyboard 13, a touchpad 14, a power switch 15 for powering on/off the PC 1, and speakers 16A and 16B are arranged.

Also, the main body 11 is provided with a power connector 21. The power connector 21 is provided on a side surface, for example, a left side surface, of the main body 11. An external power supply is detachably connected to the power connector 21. As the external power supply, an AC adapter can be used. The AC adapter is a power supply for converting commercial power (AC power) into DC power.

The battery 20 is detachably mounted on a rear end portion of the main body 11, for example. The battery 20 may be one which can be accommodated in the PC 1.

The PC 1 is driven by power from the external power supply or power from the battery 20. When an external power supply is connected to the power connector 21 of the PC 1, the PC 1 is driven by the power from the external power supply. The power from the external power supply is also used for charging the battery 20. During the time that the external power supply is not connected to the power connector 21 of the PC 1, the PC 1 is driven by the power from the battery 20.

Further, the PC 1 is provided with several USB ports 22, a High-definition Multimedia Interface (HDMI) output terminal 23, a VGA (RGB) port 24, a LAN connector 25 (not shown), and a docking station connector 26 (not shown). A docking station is an expansion unit for extending the function of the PC 1, such as addition of a storage area.

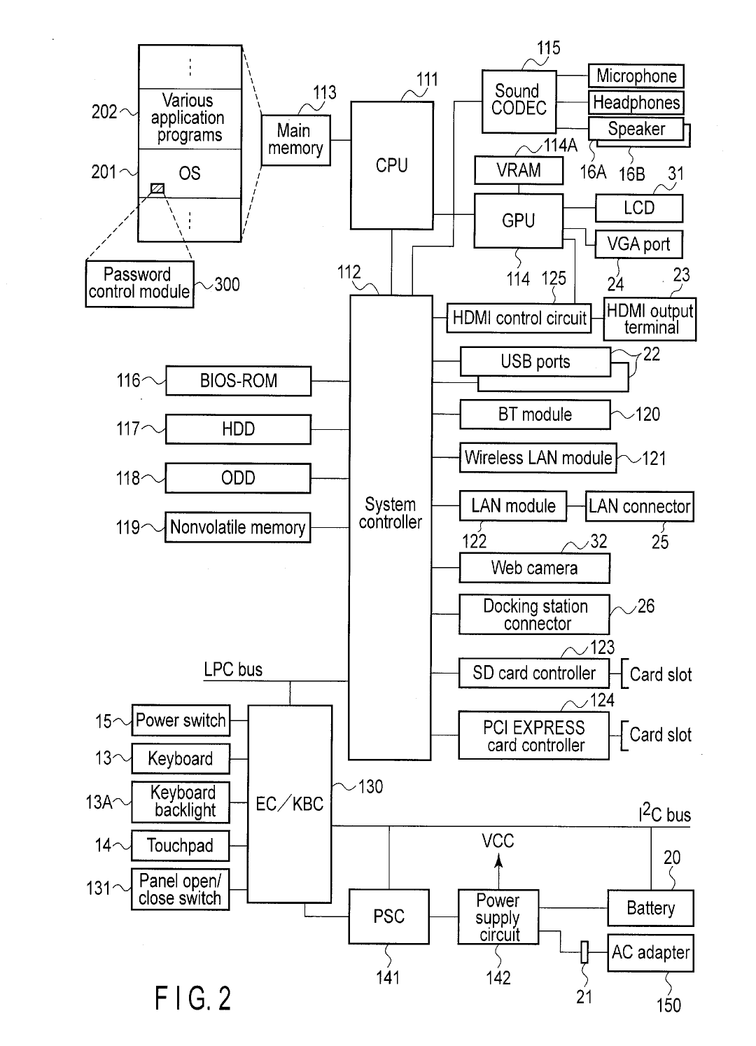

FIG. 2 is an exemplary diagram showing a system structure of the PC 1. As shown in FIG. 2, the PC 1 comprises a CPU 111, a system controller 112, a main memory 113, a graphics processing unit (GPU) 114, a sound codec 115, a BIOS-ROM 116, a hard disk drive (HDD) 117, an optical disk drive (ODD) 118, a nonvolatile memory 119, a Bluetooth (BT) module 120, a wireless LAN module 121, a LAN module 122, an SD card controller 123, a PCI EXPRESS card controller 124, an HDMI control circuit 125, an embedded controller/keyboard controller IC (EC/KBC) 130, a keyboard backlight 13A, a panel open/close switch 131, a power supply controller (PSC) 141, and a power supply circuit 142.

The CPU 111 is a processor for controlling the operation of each component of the PC 1. The CPU 111 executes various kinds of software loaded into the main memory 113 from the HDD 117. The software includes an operating system (OS) 201 and various application programs. Also, the OS 201 includes a password control module 300 to be described later.

In addition, the CPU 111 executes a Basic Input/Output System (BIOS) stored in the BIOS-ROM 116, which is a nonvolatile memory. The BIOS is a system program for hardware control.

The GPU 114 is a display controller for controlling the LCD 31 incorporated into the display unit 12. The GPU 114 generates a display signal (an LVDS signal) to be supplied to the LCD 31 from display data stored in a video memory (VRAM) 114A. The GPU 114 can also generate an analog RGB signal and an HDMI video signal from the display data. The analog RGB signal is supplied to an external display device via the VGA port 24. The HDMI output terminal 23 can send the HDMI video signal (an uncompressed digital image signal) and a digital audio signal to an external display by use of a cable. The HDMI control circuit 125 is an interface for sending the HDMI video signal and the digital audio signal to the external display device via the HDMI output terminal 23.

The system controller 112 is a bridge device for connecting between the CPU 111 and each component. A serial ATA controller for controlling the hard disk drive (HDD) 117 and the optical disk drive (ODD) 118 is built in the system controller 112. Further, the system controller 112 executes communication with each device on a Low Pin Count (LPC) bus.

The EC/KBC 130 is connected to the LPC bus. The EC/KBC 130, the power supply controller (PSC) 141, and the battery 20 are interconnected via a serial bus such as an I²C bus.

The EC/KBC 130 is a power management controller for executing power management of the PC 1, and is realized as a one-chip microcomputer with a built-in keyboard controller, for example, for controlling the keyboard (KB) 13, the touchpad 14, etc. The EC/KBC 130 comprises the function of powering on and off the PC 1 in response to an operation of the power switch 15 by a user. The control to power on and off the PC 1 is executed by a cooperative operation between the EC/KBC 130 and the power supply controller (PSC) 141. When an ON signal transmitted from the EC/KBC 130 is received, the power supply controller (PSC) 141 controls the power supply circuit 142 to power on the PC 1. Further, when an OFF signal transmitted from the EC/KBC 130 is received, the power supply controller (PSC) 141 controls the power supply circuit 142 to power off the PC 1. The EC/KBC 130, the power supply controller (PSC) 141, and the power supply circuit 142 can be operated by the power from the battery 20 or an AC adapter 150 even during a period in which the PC 1 is powered off.

Further, the EC/KBC 130 can turn on/off the keyboard backlight 13A arranged on a back surface of the keyboard 13. Furthermore, the EC/KBC 130 is connected to the panel open/close switch 131 configured to detect opening and closing of the display unit 12. Also when opening of the display unit 12 is detected by the panel open/close switch 131, the EC/KBC 130 can power on the PC 1.

The power supply circuit 142 generates power (operation power supply) to be supplied to each component by using the power from the battery 20 or the power from the AC adapter 150 connected to the main body 11 as the external power source.

Next, the function of the password control module 300 included in the OS 201 which operates on the PC 1 having the structure as described above will be described. Note that the function of the password control module 300 can be loaded into, for example, the BIOS and various application programs, not limited to the OS 201.

The password control module 300 relates to security measures for preventing the PC 1 from being illicitly used by a person other than the authorized user, and provides a mechanism for enhancing the convenience of a widespread authentication technique of authenticating the authorized user by making him/her input a preset password when the PC 1 is used.

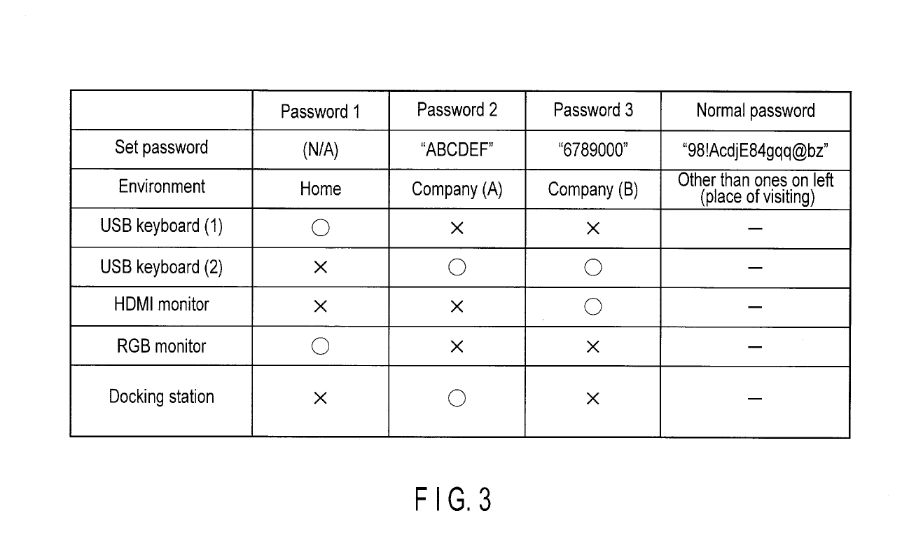

More specifically, the password control module 300 enabled changing passwords (including the case of no password) according to an environment in which the PC 1 is used. FIG. 3 shows an example of setting of passwords according to the environment in which the PC 1 is placed.

As shown in FIG. 3, it is assumed that the PC 1 is used in four types of environments which are home, company (A), company (B), and a place of visiting. Here, it is supposed that the place of visiting is the environment in which the possibility of fraud use is high, and home, company (A), and company (B) are the environments in which the possibility of fraud use is extremely low. Further, it is supposed that home has further lower risk of fraud use as compared to company (A) and company (B), and is an environment in which considerations for the fraud use is unnecessary.

Based on such a premise, the user sets a complicated and difficult password “98!AcdjE84gqq@bz” as a normal password with respect to the environment of a place of visiting, sets simple passwords “ABCDEF” and “6789000” with respect to the environments of company (A) and company (B), respectively, and performs the settings which eliminate the need for input of a password with respect to the environment of home.

Further, it is assumed that the PC 1 is used in a state where a USB keyboard (1) and an RGB monitor are connected at home, a USB keyboard (2) and the docking station are connected in company (A), and the USB keyboard (2) and an HDMI monitor are connected in company (B). Thus, the password control module 300 sets a plurality of passwords in association with the external devices connected to the PC 1, such as the USB keyboard (1), the USB keyboard (2), the HDMI monitor, the RGB monitor, and the docking station. The external device to be associated may be a single external device or a combination of two or more external devices.

In other words, the password control module 300 recognizes the external device connected to the PC 1 when the PC 1 is powered on, for example, and applies a password associated with that external device. In this way, the user is relieved of the trouble of inputting a password when the PC 1 is used at home. Further, when the PC 1 is used in company (A) and company (B), it is sufficient to input a simple alternate password instead of a normal password which is complicated and difficult. When a password which is associated with the external device connected to the PC 1 does not exist, the password control module 300 applies the complicated and difficult normal password.

Note that if the specification is one that the OS 201 can set only one password per user, when an appropriate alternate password is input in a certain environment, the password control module 300 may hand over the normal password to the OS 201 instead of the alternate password. For example, if passwords are set as shown in FIG. 3, when it has been recognized that the USB keyboard (1) and the RGB monitor are connected to the PC 1, the normal password may be handed over to the OS 201 without waiting for the input of the password.

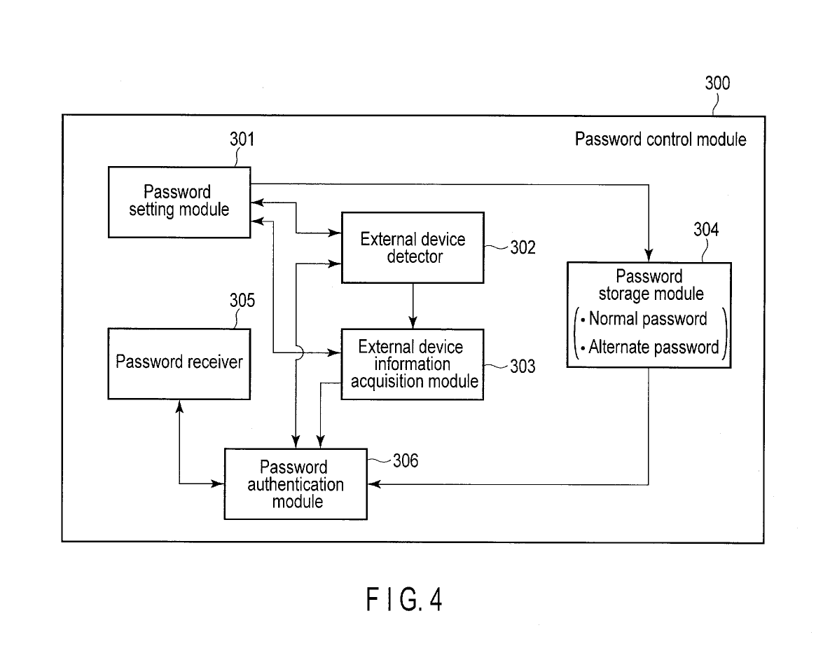

FIG. 4 is an exemplary diagram showing functional blocks of the password control module 300. As shown in FIG. 4, the password control module 300 comprises a password setting module 301, an external device detector 302, an external device information acquisition module 303, a password storage module 304, a password input module 305, and a password authentication module 306.

The password setting module 301 is a module which provides a user interface for setting the aforementioned normal password and alternate password. FIG. 5 shows an example of a user interface screen (a main screen) that the password setting module 301 displays.

As shown in FIG. 5, the password setting module 301 primarily displays the main screen for setting the normal password. On the main screen, field a1 for inputting the normal password, software button a2 for shifting to a setting screen of an alternate password, and software button a3 for confirming the setting of the normal password are provided. For example, by inputting “98!AcdjE84gqq@bz” in field a1 and operating software button a3, the user can set the normal password as shown in FIG. 3. The normal password which is set in this way is stored in the storage area assigned to the password control module 300 within the nonvolatile memory 119, for example, of the PC 1 by the password storage module 304.

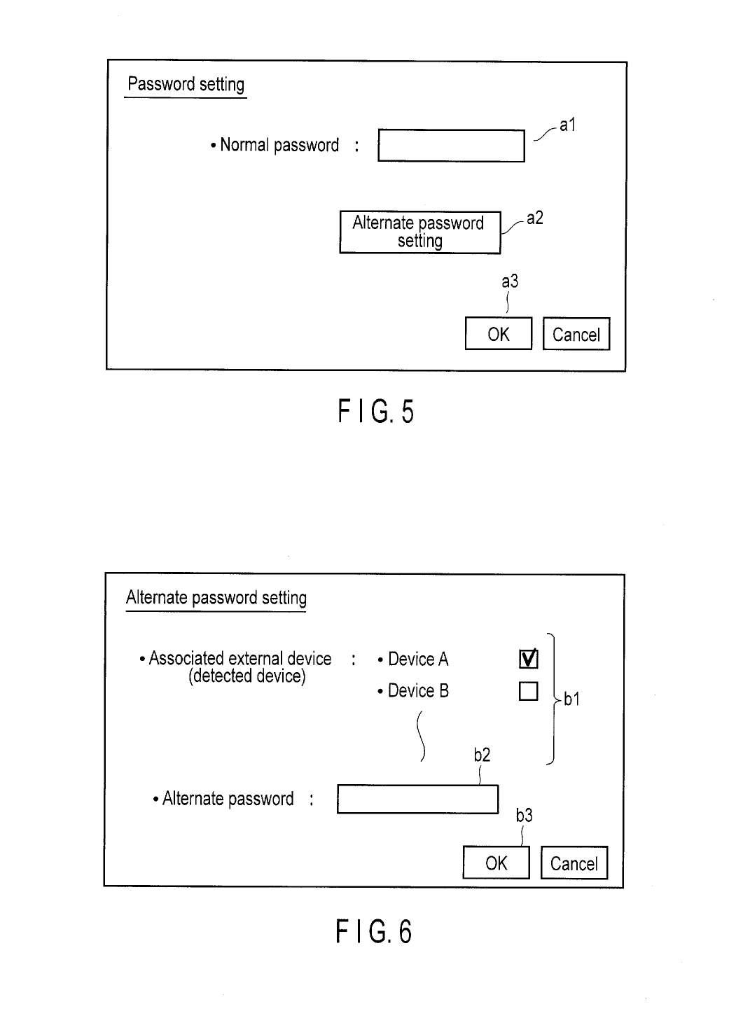

Also, when the alternate password is set, the user operates software button a2. In response to this operation, the password setting module 301 secondarily displays a subscreen for setting the alternate password. FIG. 6 shows an example of the user interface screen (the subscreen) that the password setting module 301 displays.

As shown in FIG. 6, on the subscreen, field b1, which is the field in which a list of external devices connected to the PC 1 is displayed, for selecting the external device with which the alternate password is to be associated, field b2 for inputting the alternate password, and software button b3 for confirming the setting of the alternate password are provided.

The external device detector 302 is a module for detecting the external device that is connected to the PC 1. Further, the external device information acquisition module 303 is a module for acquiring specific information on the external device in question from the external device detected by the external device detector 302. The specific information on the external devices is, for example, extended display identification data (EDID) of a display device, a descriptor of a USB device, etc. Other than the above, any kind of information can be applied as long as it is information unique to each external device. In other words, if external devices have unique information and that kind of information can be acquired from the PC 1, all those devices can be applied as the external devices with which the alternate password is to be associated.

The password setting module 301 operates the external device detector 302 and the external device information acquisition module 303 when the subscreen is displayed, and displays the external devices which are detected by the external device detector 302 and from which their respective items of specific information are acquired by the external device information acquisition module 303 in field b1 as options.

For example, the subscreen is displayed in a state where at least the USB keyboard (2) and the docking station are connected to the PC 1, and the USB keyboard (2) and the docking station are selected in field b1. Together with this, “ABCDEF” is input in field b2, and by operating software button b3, the user can set the alternate password in the environment of company (A) shown in FIG. 3. As in the case of the normal password, the alternate password which is set in this way is stored in the storage area assigned to the password control module 300 within the nonvolatile memory 119, for example, of the PC 1 by the password storage module 304.

Also, when the software button b3 is operated while field b2 is left blank, the password setting module 301 determines that the settings which eliminate the need for input of a password has been performed. Accordingly, in addition to displaying the subscreen in a state where at least the USB keyboard (1) and the RBG monitor are connected to the PC 1, and selecting the USB keyboard (1) and the RGB monitor in field b1, by operating software button b3 without inputting anything in field b2, the user can set the alternate password (i.e., no password setting [N/A]) in the environment of home as shown in FIG. 3. The settings of “no password setting” are stored in the storage area assigned to the password control module 300 within the nonvolatile memory 119, for example, of the PC 1 by the password storage module 304.

The password input module 305 is a module for inputting a password that is input on a login screen displayed when the OS 201 is activated, for example. The password authentication module 306 is a module for determining whether the user is an authorized user by using the password obtained through the password input module 305 and the passwords (the normal password and the alternate password) saved by the password storage module 304.

The password authentication module 306 operates the external device detector 302 and the external device information acquisition module 303 when the alternate password is set, and checks whether the alternate password associated with the external device which is detected by the external device detector 302 and from which specific information is acquired by the external device information acquisition module 303 exists, that is, whether such an alternate password is saved by the password storage module 304. When the alternate password exists, the password authentication module 306 compares the alternate password with the password received from the password input module 305, and if they match, the password authentication module 306 determines that the user is an authorized user. Meanwhile, when the alternate password does not exist, the password authentication module 306 compares the normal password with the password received from the password input module 305, and if they match, the password authentication module 306 determines that the user is an authorized user.

As described above, if the specification is one that the OS 201 can set only one password per user, when the user is determined as being the authorized user by the password authentication module 306, the normal password may be handed over to the OS 201.

The password control module 300 acquires the specific information from the external device, and manages the alternate password in association with the acquired specific information on the external device in the PC 1 side. Thus, there is no need to write information in the external device side. Accordingly, existing various external devices can be applied as long as they have specific information.

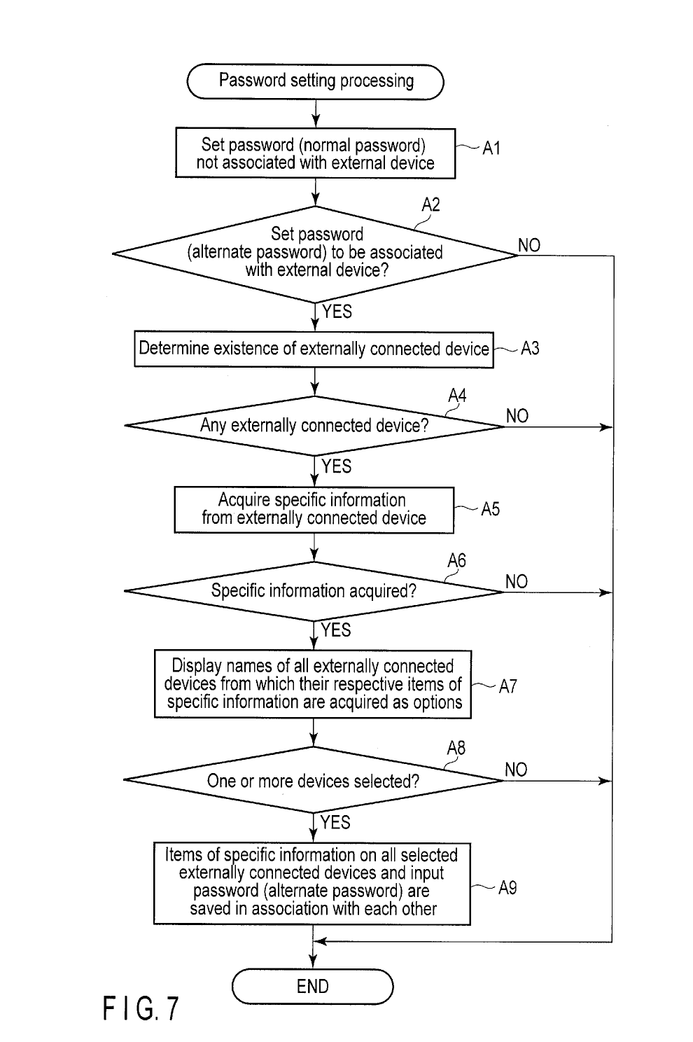

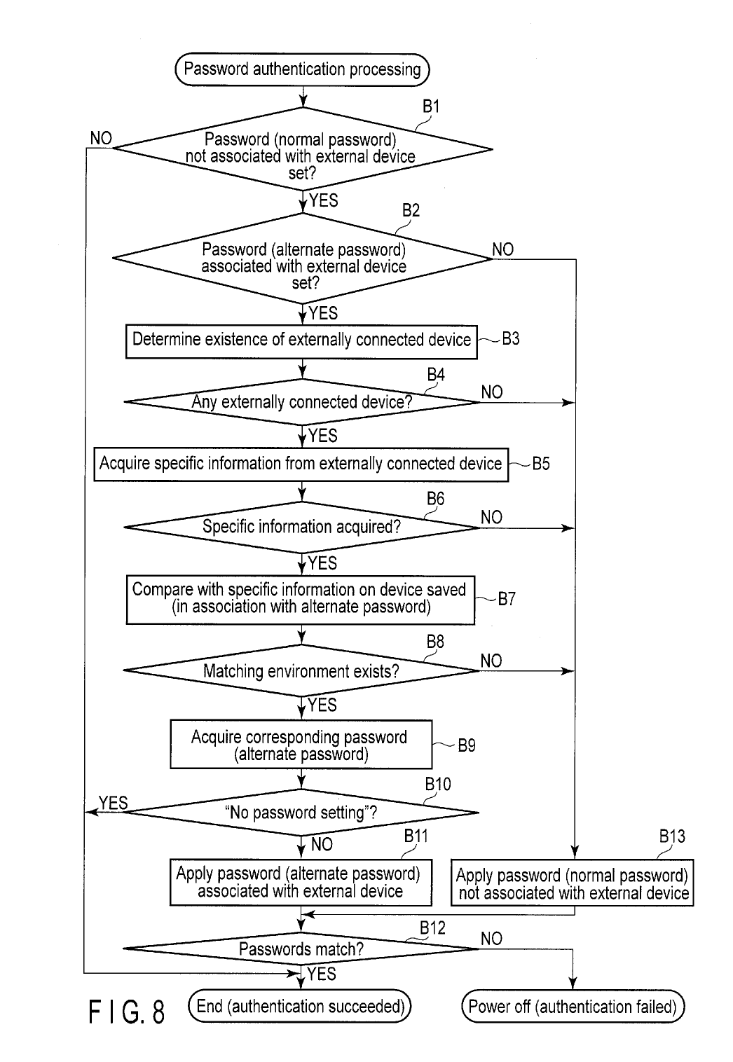

FIG. 7 is an exemplary flowchart showing procedures of password setting processing executed by the PC 1.

Firstly, the PC 1 sets a password which is not associated with the external device, that is, sets a normal password (block A1). When the PC 1 is to set a password associated with the external device, that is, an alternate password, (YES in block A2), existence of an externally connected device is determined (block A3). When the externally connected device exists (YES in block A4), the PC 1 acquires specific information from the externally connected device (block A5).

When the specific information could be acquired (YES in block A6), the PC 1 displays names of all of the externally connected devices from which their respective items of specific information are acquired as options (block A7). If one or more devices are selected (YES in block A8), items of specific information on the all of the externally connected devices which are selected and the alternate password which has been input are saved in association with each other (block A9).

Further, when there is no externally connected device (NO in block A4) or the specific information cannot be acquired (NO in block A6), the PC 1 terminates the processing without setting the alternate password.

FIG. 8 is an exemplary flowchart showing steps of password authentication processing executed by the PC 1.

Firstly, the PC 1 checks whether a password which is not associated with the external device, that is, a normal password, has been set (block B1). When the normal password is not set (NO in block B1), the PC 1 terminates the processing assuming that the authentication succeeded. When this processing terminates normally, the OS 201 is activated.

When the normal password is set (YES in block B1), the PC 1 checks whether a password associated with the external device, that is, an alternate password, has been set (block B2). When the alternate password is set (YES in block B2), the PC 1 determines existence of an externally connected device (block B3). When the externally connected device exists (YES in block B4), the PC 1 acquires specific information from the externally connected device (block B5).

When the specific information could be acquired (YES in block B6), the PC 1 compares the acquired specific information with the specific information on the device which has been saved in association with the alternate password (block B7).

When there is an environment in which items of specific information on the devices match exactly without excess and deficiency (YES in block B8), the PC 1 acquires the password (including the case of no password) corresponding to that environment (block B9). In the case of “no password setting” (YES in block B10), the PC 1 terminates the processing assuming that the authentication succeeded. If a password has been set (NO in block B10), the PC 1 applies that password, that is, the alternate password (block B11), and compares it with the input password (block B12). If these passwords match (YES in block B12), the PC 1 terminates the processing assuming that the authentication succeeded. If the passwords do not match (NO in block B12), the PC 1 turns off power assuming that the authentication failed.

Further, in all cases where the alternate password is not set (NO in block B2), there is no externally connected device (NO in block B4), specific information cannot be obtained (NO in block B6), and there is no environment in which items of specific information on devices match exactly without excess and deficiency (NO in block B8), the PC 1 applies the normal password (block B13) and compares it with the input password (block B12). If these passwords match (YES in block B12), the PC 1 terminates the processing assuming that the authentication succeeded. If the passwords do not match (NO in block B12), the PC 1 turns off power assuming that the authentication failed.

As described above, according to the present PC 1, a password (including the case of no password) can be changed according to the environment in which the PC 1 is used, and it is possible realize enhancement of the convenience of a widespread authentication technique of authenticating the authorized user.

Note that each of various functions described in the present embodiment may be realized by a processing circuit. Examples of the processing circuit include a programmed processor such as a central processing unit (CPU). The processor executes each of the described functions by executing a program stored in a memory. The processor may be a microprocessor including circuitry. Examples of the processing circuit include a digital signal processor (DSP), application specific integrated circuits (ASIC), a microcontroller, a controller, and other electric circuit components.

Since various types of processing of the present embodiment can be realized by a computer program, it is possible to easily realize an advantage similar to that of the present embodiment by simply installing a computer program on an ordinary computer by way of a computer-readable storage medium having stored thereon the computer program, and executing this computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an input controller configured to receive a password; and
circuitry configured to detect an external device which is externally connected, and to determine whether the password received by the input controller matches a password set in association with the detected external device.

2. The apparatus of claim 1, wherein the circuitry is configured to set the password in association with a combination of at least two external devices.

3. The apparatus of claim 1, wherein the circuitry is configured to perform settings which eliminate a need for inputting the password in association with the external device.

4. The apparatus of claim 1, wherein the circuitry is configured to:
set a first password and a second password, the first password being not associated with the external device, the second password being associated with the external device;
compare the second password with the password received by the input controller when the second password set in association with the detected external device exists; and
compare the first password with the password received by the input controller when the second password set in association with the detected external device is nonexistent.

5. The apparatus of claim 1, wherein the circuitry is configured to acquire specific information on the external device which is externally connected, and to store the password set in association with the external device and the acquired specific information on the external device such that they correspond to each other.

6. The apparatus of claim 5, wherein the specific information on the external device comprises extended display identification data (EDID) of a display device which is externally connected.

7. The apparatus of claim 5, wherein the specific information on the external device comprises a descriptor of a USB device which is externally connected.

8. An authentication method performed by an electronic apparatus, the method comprising:
receiving a password;
detecting an external device which is externally connected; and
determining whether the received password matches a password set in association with the detected external device.

9. The method of claim 8, further comprising setting the password in association with a combination of at least two external devices.

10. The method of claim 8, further comprising performing settings which eliminate a need for inputting the password in association with the external device.

11. The method of claim 8, further comprising setting a first password and a second password, the first password being not associated with the external device, the second password being associated with the external device,
wherein the determining comprises comparing the second password with the received password when the second password set in association with the detected external device exists, and comparing the first password with the received password when the second password set in association with the detected external device is nonexistent.

12. The method of claim 8, further comprising:
acquiring specific information on the external device which is externally connected; and
storing the password set in association with the external device and the acquired specific information such that they correspond to each other.

13. A computer-readable, non-transitory storage medium having stored thereon a computer program which is executable by a computer comprising a multiuser function, the computer program controlling the computer to function as:
an input controller configured to receive a password; and
circuitry configured to detect an external device which is externally connected, and to determine whether the password received by the input controller matches a password set in association with the detected external device.

14. The medium of claim 13, wherein the circuitry is configured to set the password in association with a combination of at least two external devices.

15. The medium of claim 13, wherein the circuitry is configured to perform settings which eliminate a need for inputting the password in association with the external device.

16. The medium of claim 13, wherein the circuitry is configured to:
set a first password and a second password, the first password being not associated with the external device, the second password being associated with the external device;
compare the second password with the password received by the input controller when the second password set in association with the detected external device exists; and
compare the first password with the password received by the input controller when the second password set in association with the detected external device is nonexistent.

17. The medium of claim 13, wherein the circuitry is configured to acquire specific information on the external device which is externally connected, and to store the password set in association with the external device and the acquired specific information on the external device such that they correspond to each other.

18. The medium of claim 17, wherein the specific information on the external device comprises extended display identification data (EDID) of a display device which is externally connected.

19. The medium of claim 17, wherein the specific information on the external device comprises a descriptor of a USB device which is externally connected.
